(19) United States
(12) Patent Application Publication
(10) Pub. No.: US 2006/0080615 A1
(43) Pub. Date: Apr. 13, 2006

(54) Method, apparatus and software for business and financial analysis

(75) Inventor: Kelly D. Myers, Santa Fe, NM (US)

Correspondence Address: PEACOCK MYERS, P.C., 201 THIRD STREET, N.W., SUITE 1340, ALBUQUERQUE, NM, 87102, US

(73) Assignee: Commodicast, Santa Fe, NM (US)

(21) Appl. No.: 10/977,153

(22) Filed: Oct. 29, 2004

Related U.S. Application Data
(60) Provisional application No. 60/515,979, filed on Oct. 29, 2003.

(51) Int. Cl. G06F 3/00; G06F 9/44

(52) U.S. Cl. 715/764; 705/7

(57) ABSTRACT

A method and computer software for displaying information about an organization comprising code representing a plurality of factors of the organization as a corresponding plurality of displayed interlocking gears and code causing the displayed gears to rotate in accordance with simulated increasing or decreasing of the corresponding factors.

### CROSS-REFERENCE TO RELATED APPLICATIONS

This application claims the benefit of the filing of U.S. Provisional Patent Application Ser. No. 60/515,979, entitled “Method, Apparatus, and Software for Business and Financial Analysis”, filed on Oct. 29, 2003, and the specification thereof is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

A compact disc appendix is included containing computer program code listings pursuant to 37 C.F.R. 1.52(e) and is hereby incorporated by reference in its entirety. The total number of compact discs is 1 including 11 files and 375,968 bytes. The files included on the compact disc are listed in a file entitled “dir_s” on the compact disc. The required listing of file names, dates of creation and sizes in bytes is included in the file dir_s on the compact disk and incorporated by reference herein.

### COPYRIGHTED MATERIAL

© 2003-2004 Commodicast, Inc. and Alliance Performance Systems, Inc. A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field):

The present invention relates to methods, apparatuses, and software for business and financial analysis.

2. Description of Related Art

In modern business environments, the amount of variables to keep in mind in analyzing a business is astounding. Manners in which to depict the interconnectedness of these variables are typically unintuitive and/or do not contribute to an understanding of a business organization.

The present invention depicts the major components of a business as gears in a system driven by the major variables. This depiction provides for both a better gestalt and detailed understanding of a complex business or other organization.

### BRIEF SUMMARY OF THE INVENTION

The present invention is of a method and computer software for displaying information about an organization, comprising: code representing a plurality of factors of the organization as a corresponding plurality of displayed interlocking gears; and code causing the displayed gears to rotate in accordance with simulated increasing or decreasing of the corresponding factors. In the preferred embodiment, the causing code generates directly interlocking gears rotating in opposite directions, with code further provided that generates facilitating gears interlocking two gears corresponding to two factors of the organization which increase and decrease together. The representing code comprises code representing a plurality of factors selected from the group consisting of organization membership, costs, revenues, cost of revenues, gross profit, operating income, net income, taxes, accounts payable, accounts receivable, and equity. Code is further provided permitting a user to click on a gear to receive a graphical display of change of the corresponding factor over time, graphically alerting a user via a corresponding gear if a factor exceeds or falls below a predetermined set point, permitting a user to change a speed at which the causing step occurs, permitting a user to alter speeds at which one or more factors increase or decrease, and permitting a user to load a plurality of organization's data as the factors corresponding to the gears of the display. The causing code is preferably executed via an HTML browser.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is an illustration of an exemplary display of the invention for a dialysis center;

FIG. 2 is an illustration of an exemplary display of the invention for a hospital;

FIG. 3 is an illustration of an exemplary display of the invention for a managed care organization;

FIG. 4 illustrates the various components of the exemplary displays;

FIG. 5 is an example of data presentation when a user clicks on a gear representing the contained data;

FIG. 6 is an example of data presentation when a user clicks on a particular quarter represented by a line segment of FIG. 5; and

FIGS. 7-16 illustrate the development of a gear model of an organization according to the invention and as described in Example 4.

### DETAILED DESCRIPTION OF THE INVENTION

The present invention is of a method and software for depicting components of a complex organization and their interconnectedness using gears in the depiction. Certain gears represent business drivers. Gears in direct contact spin in opposite directions. Preferably, a clockwise spin represents a factor that is increasing over time, while a counterclockwise spin represents a factor that is decreasing over time.

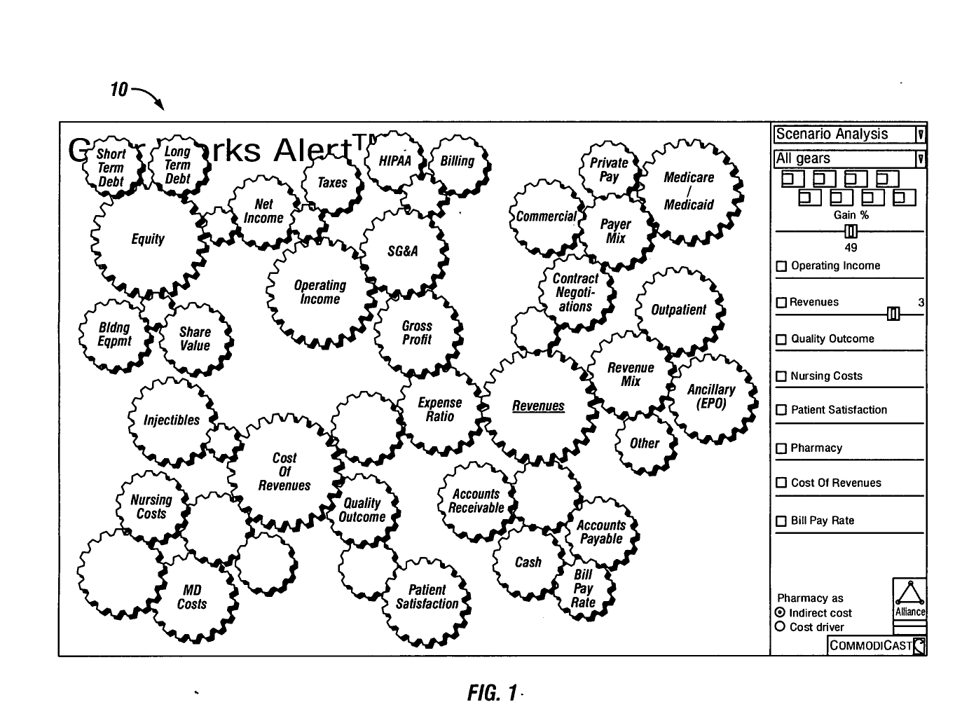

The preferred embodiment of the software of the present invention is referred to herein as “GearWorks Alert™”, and comprises software generated via-Macromedia Director™. The CD-ROM appendix hereto contains ASCII versions of the Macromedia Director™ scripts and cast text fields of the preferred software of the invention, as well as the supporting Hypertext Markup Language (HTML) files. Three different examples of businesses simulated by the GearWorks Alert software are provided corresponding to the browser images of FIGS. 1-3. One of ordinary skill in the art could generate the present invention without undue experimentation having the CD-ROM appendix and the present specification and drawings.

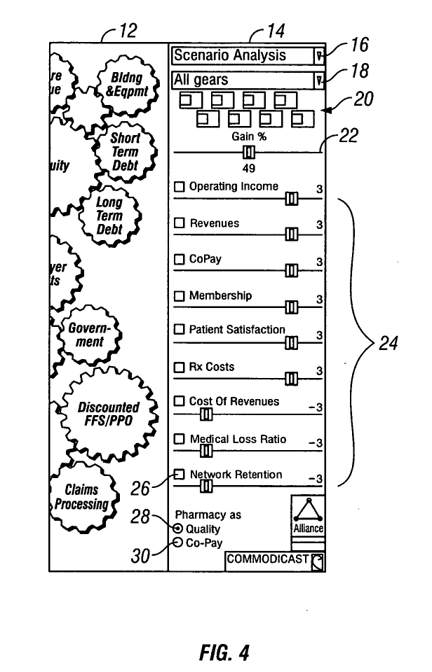

GearWorks Alert is preferably made accessible via an HTML (web) browser over the Internet or an Intranet of an organization. A username and password system is preferably employed for security purposes. If the user does not have a Macromedia Shockwave™ plug-in installed in the user's browser, the user is redirected to Macromedia's website for downloading and installation. Once downloaded, the user will see a display similar to the examples of FIGS. 1-3, the exemplary display 10 being detailed in FIG. 4.

Referring to FIG. 4, the user is presented with a gear board 12 and a grey bar 14 to its right. This bar contains tools that are available to the user. The tools preferably include a button 16 to switch between Scenario Analysis and Company Analysis views. Button 18 permits the user to select all or a specific group of gears, such as all gears associated with finance. Color coded panel 20 provides another means by which to select and deselect groups of gears (e.g., all gears but those in red). The Gain % slider bar 22 allows the user to increase or decrease the gear speed of the entire system. The panel of slider bars 24 allow one to adjust and experiment with different driver variable values for the system permitting one to engage in, e.g., “what if” scenarios. The slider bars allow one to increase or decrease the effects of the corresponding variables. The black boxes 26 to the left of the slider bars turn the corresponding driver on or off. Clicking on the circle 28 next to Quality allows one to view the effects of Membership in an organization when driven by Quality; clicking on the Co-Pay circle 30 allows one to view the effects of Membership when driven by Co-Payment receipts.

Button 16 provides a drop down menu having two functions, Scenario Analysis and Company Analysis. Scenario Analysis allows one to view the financial environment of an organization using hypothetical data. The purpose of this tool is to allow one to understand the organization's business drivers and their affects on each other and other parts of the organization. The Scenario Analysis view lets one create “what if” studies and see the effects on other drivers.

Company Analysis allows one to view a list of organizations for which the system has actual data obtained, for example, from their most recent financial reporting documents. One can review the list and click on a company that is of interest.

Button 18 provides a drop down menu allowing one to choose a preferred view of the gearboard, i.e., all the gears or specific areas of the gear board (e.g., selected from Finance, Sales & Marketing, Member Services, Pharmacy Director, and Provider Services for a Managed Care Organization (MCO)). One selects the view one wishes to see by clicking on the area to be isolated. The gears associated with that area of the organization will remain on-screen, and the others will fade out (e.g., by graying).

Panel 20 permits clicking on a color box will turn a gear color group “off” or “on” so that one may view that gear group in any combination with other gear groups.

The Gain % slider bar 22 is a tool that allows one to adjust the speed of the gears across the entire system.

When using the Scenario Analysis screen, slider bars 24 allow one to experiment with different combinations of setting of drivers. Moving the sliders allows one to increase or decrease business drivers and view the consequences that are likely to occur due to such actions. It is preferred that the scales on the sliders be normalized, such as from −5 on the left to +5 on the right.

When using the Scenario Analysis screen in the preferred embodiment for a healthcare organization, one can choose to see the gear movements using two strategies: Membership driven by Quality 28, or Membership driven by Co-pay 30. Quality allows one to view the effects of Membership when driven by Quality; clicking on Co-Pay circle allows one to view the effects of Membership when driven by Co-Pay.

A user using the system of the invention can glean much useful information to aid in managing the organization. In healthy financial systems, revenues increase at a rate faster than expenses, and gross profits increase steadily. In less healthy environments, the opposite might occur.

Gears with labels are important business driver in a financial system. For example, the REVENUES gear represents the income producing items that make up all of the Revenues for a company. Gears without labels are facilitating gears. Gears that are connected by a facilitating gear will turn in the same direction. Gears turning clockwise indicate an increase. For example, if the REVENUES gear is turning clockwise, Revenues are going up from reporting period to reporting period. Gears turning counter-clockwise indicate a decrease. A gear that is wobbling, frozen or is spinning rapidly indicates a potential problem in the financial system worth investigating further.

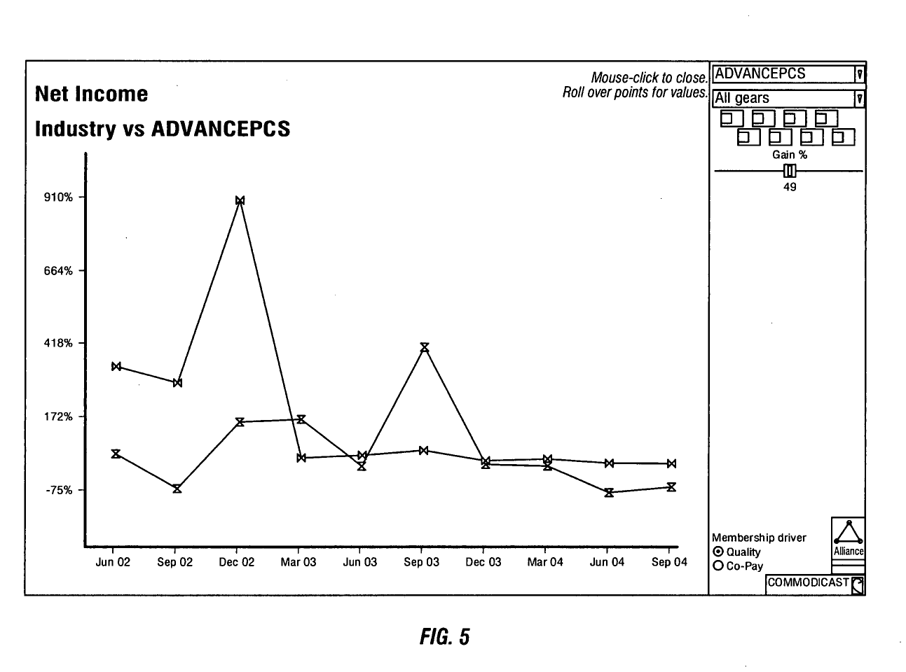

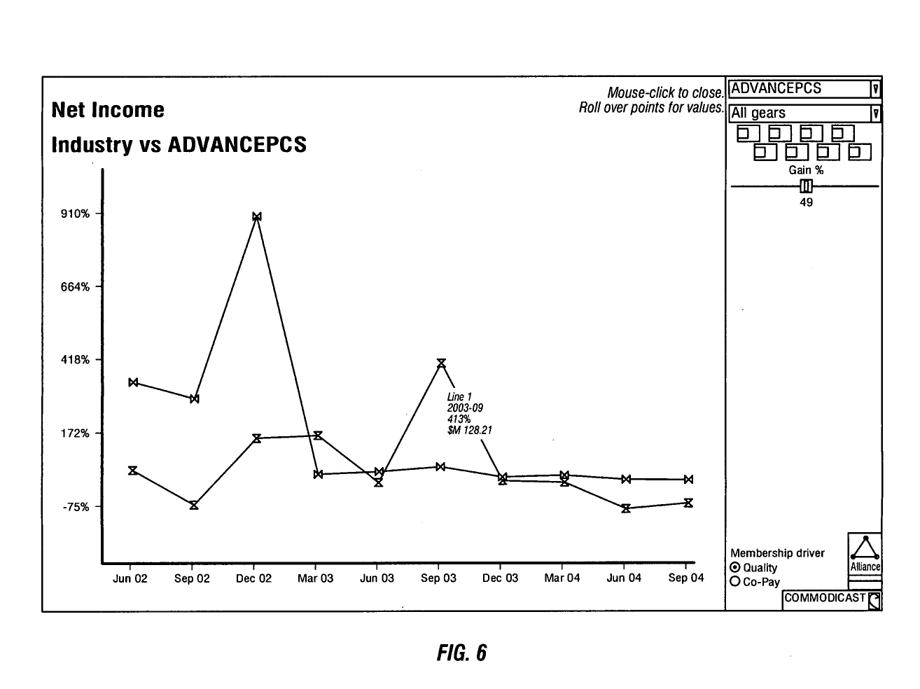

When one is viewing the gears for a selected company, the invention will flag gears such as by using underlined labels or pulsing to indicate gears that contain financial data. To see the data, once can simply click on the gear and a presentation of the data, for example a trend graph, will appear. Colored lines can be employed to correspond to a color coded key in the upper left corner of the screen, as illustrated in FIG. 5. To view data for each quarter, one can click on the corresponding data point on the line, receiving a display such as shown in FIG. 6. To return to the gear board, one can simply click anywhere on the white portion of the screen.

If a user sees wobbling, frozen, or rapidly spinning actions on the board, the user may wish to click on the data behind the gear to see the numerical (e.g., dollar) figure that that gear represents. Then, one may want to do some investigative work to help better understand what may be happening at the company with respect to the aspect represented by the gear in question. For example, one may see that COST OF REVENUES is spinning clockwise at a much faster pace than REVENUES. One reason for this event could be that the company is expanding and spending more money in the short-term (such as purchasing needed expensive medical equipment) in order to bring in more Revenues in the long-term for the company. Alerts may also be indicated in this fashion, such as to flag events such as Total Liabilities exceeding a set amount, Liquidity going above or below a set amount, claims Payment Rate going above or below a set amount, etc. Another manner in which alerts may be indicated is to cause a color pattern of a gear to change, such as by a shading flowing radially until the affected gear is clicked upon to display data concerning the alert (e.g., a graph such as in FIG. 5). Alerts may also be indicated by one gear spinning much faster than another.

More complex alerts may also be established. For example, a useful claims Payment Rate alert can be estalished to flag a large increase in Accounts Payable not matched by increases in Revenues and Cash. The preferred logic for the alert condition is:

Accounts Payable>=0.25 AND

NOT (Revenues>0 AND Accounts Payable/Revenues<3) AND

NOT (Cash>0 AND Accounts Payable/Cash<3)

A useful Liquidity Rate alert is can be established to flag negative Operating Income with Accounts Receivable+Cash<Accounts Payable+Short Term Debt. A useful Total Liability alert can be established to flag Equity much less than Short+Long Term Debt+Accounts Payable+Taxes,” with the preferred threshold for the condition being Equity/sum<=0.5.

### INDUSTRIAL APPLICABILITY

The invention is further illustrated by the following non-limiting examples.

### EXAMPLE 1

FIG. 1 illustrates the display of the invention as might be developed for a dialysis center.

### EXAMPLE 2

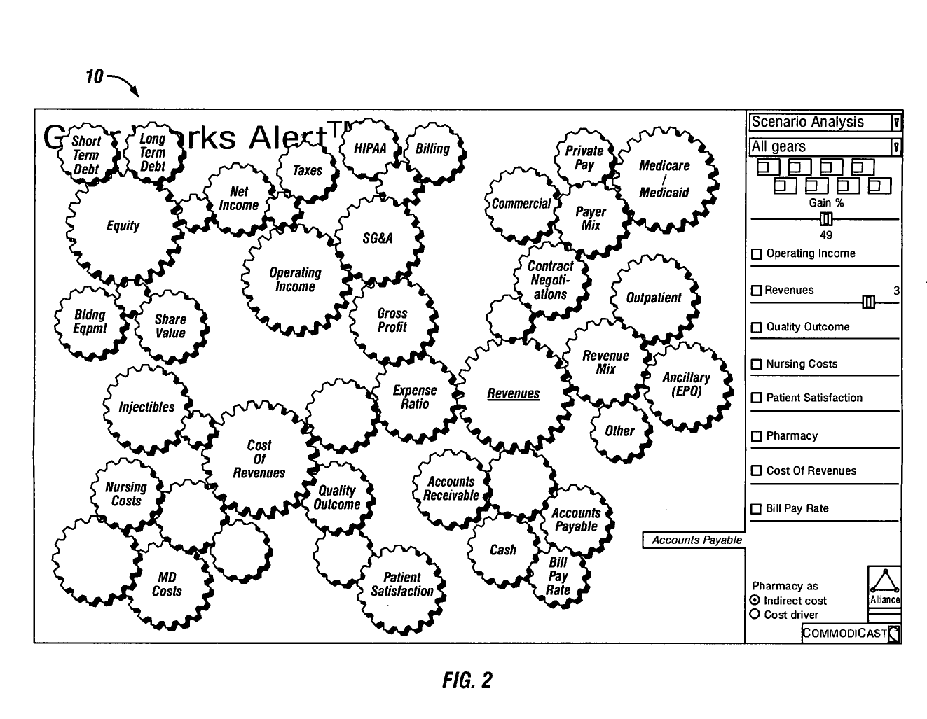

FIG. 2 illustrates the display of the invention as might be developed for a hospital.

### EXAMPLE 3

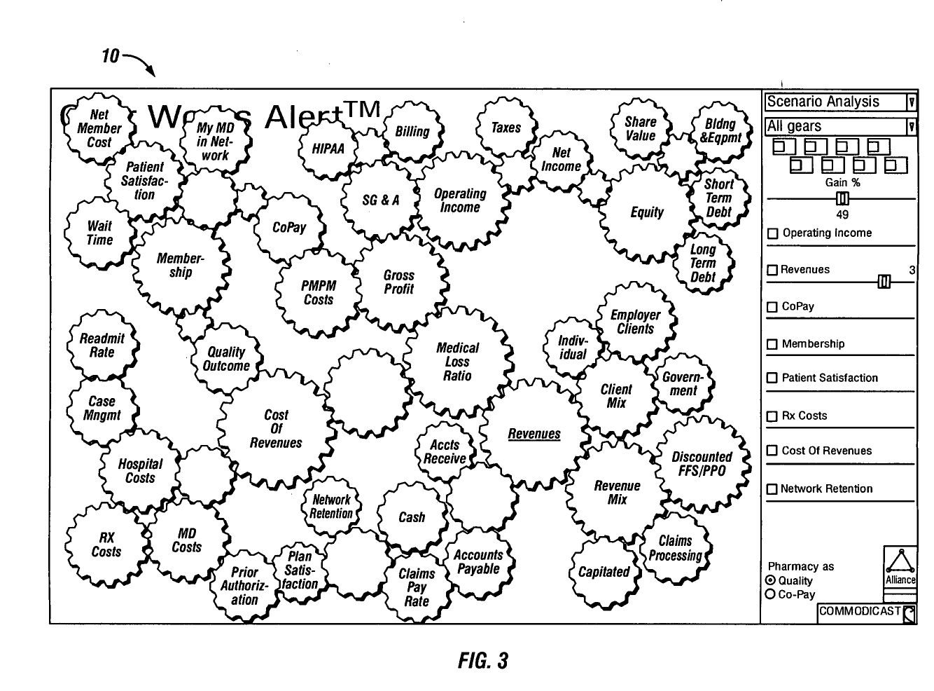

FIG. 3 illustrates the display of the invention as might be developed for a managed care organization.

### EXAMPLE 4

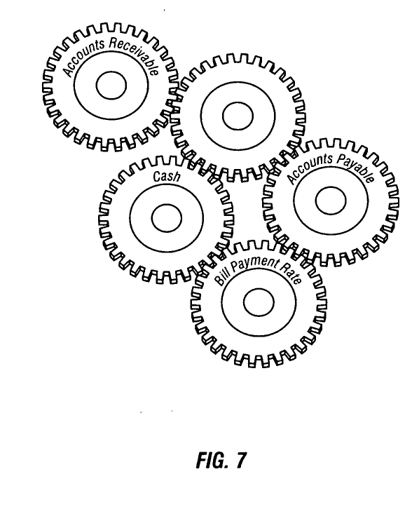

FIGS. 7-16 illustrate the development of a business drivers simulation according to the invention for a healthcare organization. The theory and rationales behind such development are next presented for better understanding of the versatility and utility of the invention.

Healthcare organizations are huge systems with many moving parts. One way to understand the system is to take a look at the key business drivers impacting the financial health (profitability) of the organization as a whole as well as trends affecting the entire industry.

To comprehend the impact of business decisions or company initiatives and the accompanying ripple effects of such decisions as they flow through the whole organization, broad knowledge of the interdependencies of the parts is required. Although the relationship between some parts is clear on financial statements (e.g., Revenues, Cost of Revenues, Operating Income), the relationship of other parts can be harder to determine (e.g., business drivers, key ratios, industry trends, customer satisfaction, and network retention)—important drivers not necessarily found on standard financial statements.

The present invention employs a metaphor to help identify the inter-relationship of various parts of an organization's overall system (e.g., an entire healthcare organization), namely the use of gears. Gears preferably represent business drivers because: (1) Gears can best reflect the inter-relationships between the various parts of care settings; (2) The unique mechanics of gears allow one to see implications, often unexpected, on other areas of an environment; and (3) Each gear can represent a key business driver in a system.

The gear board of the software of the invention represents the many moving parts of an organization's (e.g., a hospital's) financial system. Each movement of the system, one that positively affects a gear, and conversely, a movement that negatively affects a gear, drives the performance of the entire system. The preferred mechanics of using gears are next discussed.

Whether the gear represents cost, revenue, or volume, a clockwise motion preferably represents an increase, counter-clockwise a decrease. If two gears are in direct contact, they turn in opposite directions. For example, referring to FIG. 7, Accounts Payable and Bill Payment Rate are directly connected. As a business increases the rate it pays its bills (gear moves clockwise), its Accounts Payable balance decreases (gear moves counter-clockwise). Sometimes a facilitating gear (see the gear without a label) joins two other gears. This facilitating gear allows the connecting gears to turn in the same direction. In FIG. 7, Accounts Receivable and Revenues are an example of this type of relationship. Generally, as Accounts Receivable increases, Revenues also tend to increase (gears move in the same direction).

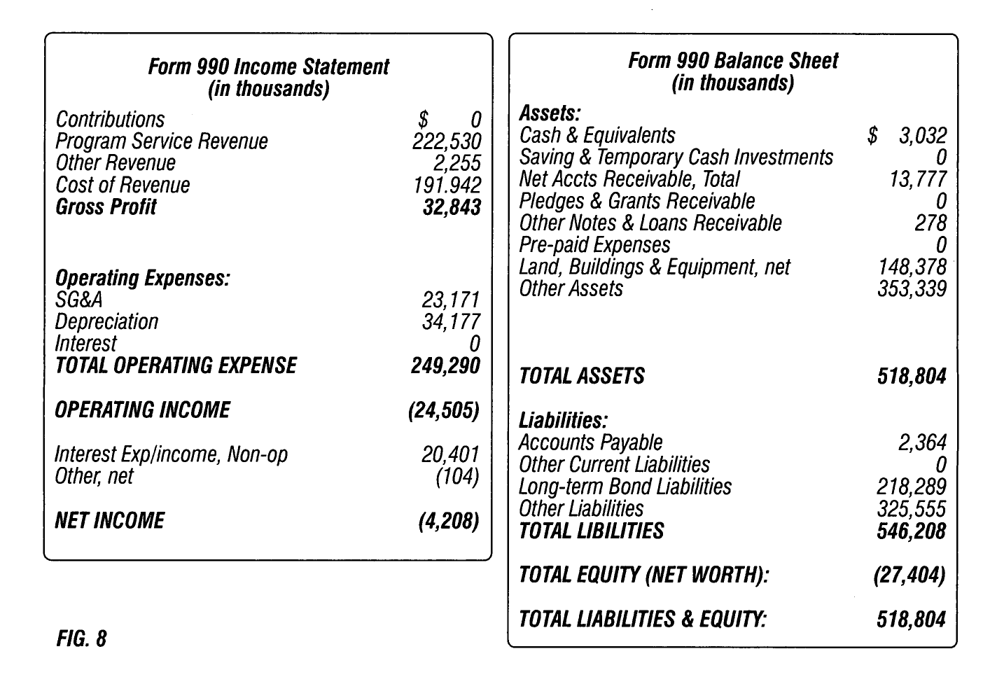

This example next describes the process of building an entire organizational system in eight steps. As one builds a system in steps, one has the opportunity to see the impact that each driver has on other areas of the system. As one builds a system, one can turn the various business drivers clockwise and counter-clockwise and closely observe the impact in other areas of the system. This helps one understand an organization's entire financial environment, not just some of its parts. As one builds a financial system of business drivers, it is helpful to think from the perspective of various roles within that organization. As an illustration, the financials of a fictitious hospital organization, Midwest Health Systems (MHS), are depicted in FIG. 8.

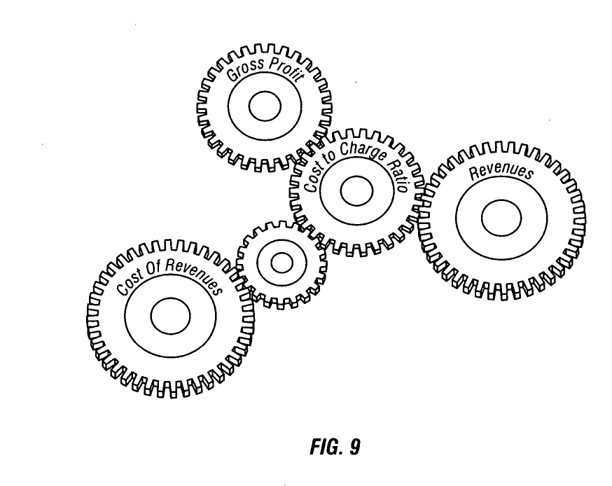

Step 1 involves key drivers seen in FIG. 9: Gross Profit, Revenues, Cost of Revenues, and one important ratio, the Cost to Charge Ratio. If one moves the Revenues gear clockwise, representing an increase in Revenues, one will notice the effect on the other gears. In a financially healthy care setting, Revenues should out-pace Cost of Revenues, but there are exceptions. For example, if a company is in a growth phase, they may temporarily increase expenses to prepare for the increased demand anticipated. It is also possible for Revenues and Cost of Revenues to increase at the same rate. This is healthy for a care setting as long as Revenues eventually grow faster than Cost of Revenues.

Refer to the Cost to Charge Ratio, which is calculated by dividing the Cost of Revenues by the Revenues. This driver is an important metric that can reflect the overall health of a care setting. The lower the Cost to Charge Ratio, the more profitable the organization. When moving the Revenues gear clockwise, as long as Revenues are increasing at a faster rate than Cost of Revenues, the Cost to Charge Ratio will decrease. Gross Profit also increases as long as Revenues are outpacing Cost of Revenues.

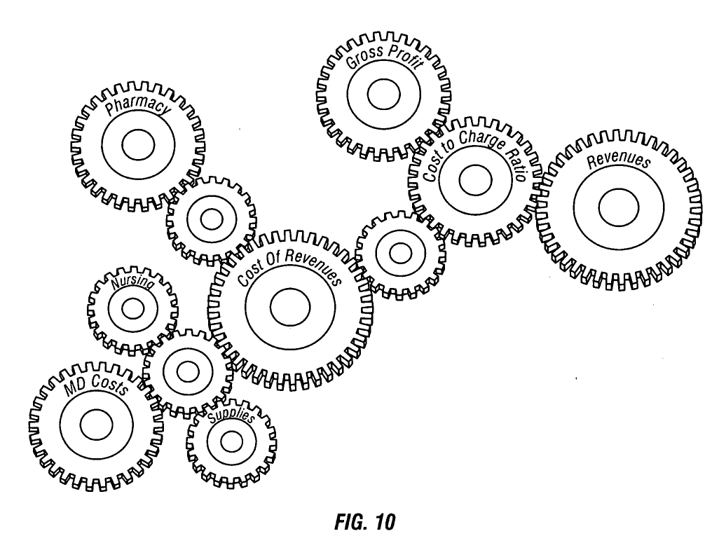

Referring to FIG. 10, Step 2 adds gears including MD (Medical Doctor) Costs, Nursing, Supplies, and Pharmacy. These gears are general Expenses that make up the Cost of Revenues driver. Cost of Revenues includes only the Expenses directly associated with delivering the goods and services needed to provide healthcare, in this example. In other words, the physician and nursing salaries and the products used to directly provide healthcare make up Cost of Revenues. Overhead Expenses, such as the office lease, an office manager's salary, etc. are not part of Cost of Revenues.

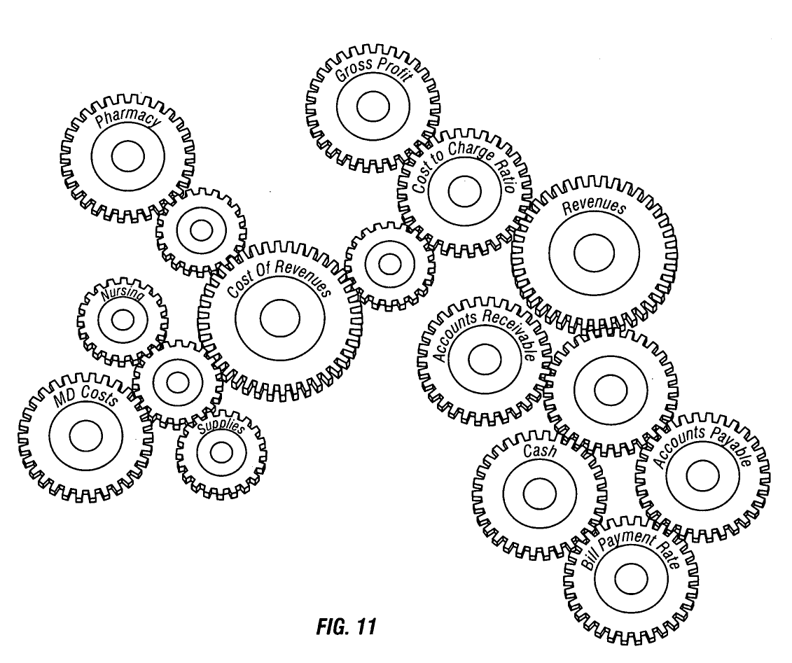

Step 3 adds further gears, as shown in FIG. 11. Accounts Receivable is the money that is owed to the care setting for goods and services provided. Accounts Payable is the money the care setting owes to other organizations. Of course, Cash refers to the cash on hand that has been deposited into bank accounts. Bill Payment Rate is an important driver in the system because it represents the rate at which a care setting pays its bills. This key business driver is sometimes an indicator of a care setting's financial situation. For example, if MHS is having a cash flow problem, they may decide to counter this problem by prioritizing their Accounts Payable and leaving some bills to be paid the next period. This may be a short-term “fix,” but there will be certain repercussions. As they slow down their Bill Payment Rate (move the gear counter-clockwise), it will indeed help the Cash situation but will also raise Accounts Payable for the next period.

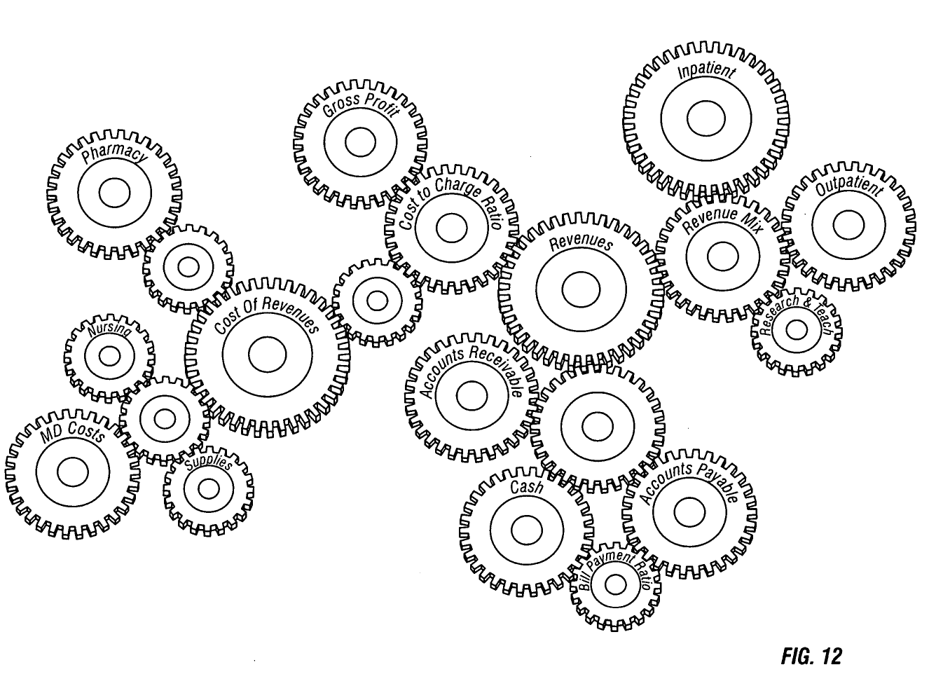

In Step 4, referring to FIG. 12, further gears are added. Revenue Mix is a driver consisting of all sources of Revenues obtained from the sale of services and products. Hospital systems obtain Revenues from any combination of inpatient, outpatient, ancillary services, medical research, laboratory services, teaching, and other services. Other Revenues could be derived from normal, day-to-day operations unrelated to patient care, such as Revenues from vending machines. These are costs to the system until they are reimbursed by a payor. A payor can be an MCO or other commercial payors, such as Medicare, Medicaid, or a patient. Once reimbursed, the costs are converted into Revenues for the system.

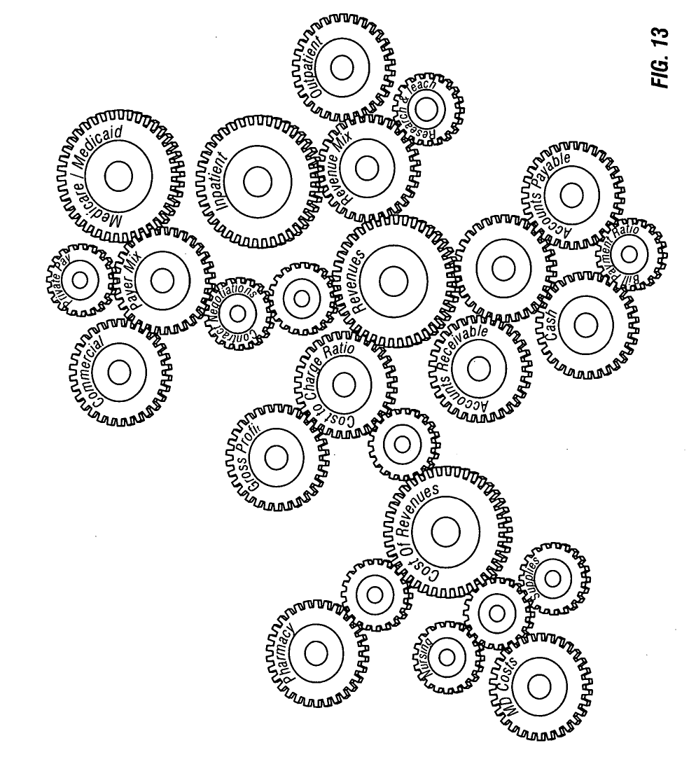

Step 5, referring to FIG. 13, adds further gears. Payor Mix relates to reimbursement by various payors for products and services related to healthcare they provide to patients. There can be a variety of payors in a system's Payor Mix, including Commercial Payors (e.g., HMO, PPO, MCO, other insurance companies), Private Pay (self-insured patients, co-pay), and Government Payors (Medicare and/or Medicaid). Payors use varying calculations to reimburse providers for approved products. Payor Mix can be quite different from business to business, depending upon such things as the demographics of the surrounding area.

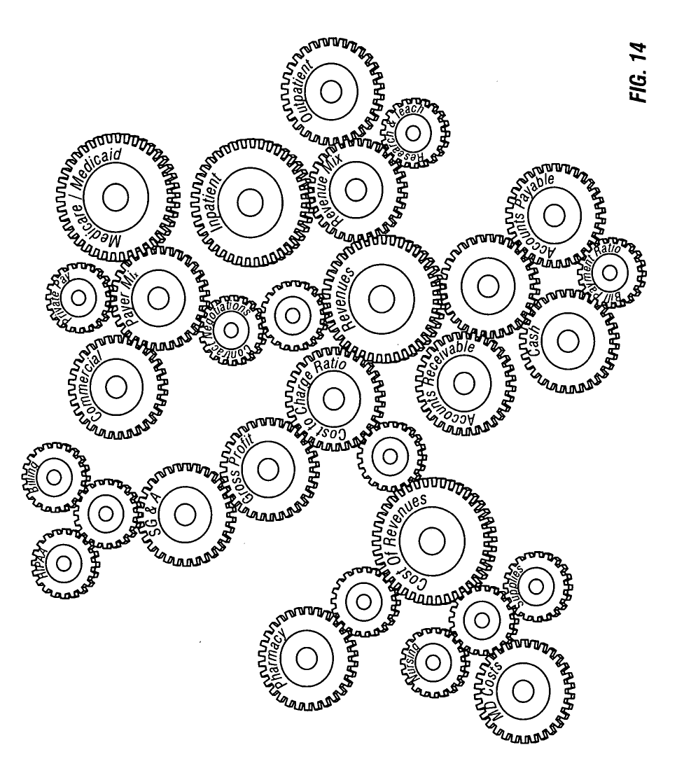

Step 6, referring to FIG. 14, adds still further gears relating to Indirect Expenses, which are the Expenses that are not directly related to the delivery of healthcare services, but rather are involved in the cost of operating the business, such as a driver called Selling, General, and Administrative (SG&A). SG&A typically includes office advertising and promotion, travel and entertainment, and office payroll. HIPAA relates to the Health Insurance Portability and Accountability Act, a cost specific largely to the healthcare industry. The payroll, in MHS' case, would be for the non-medical staff such as legal, accounting, and maintenance.

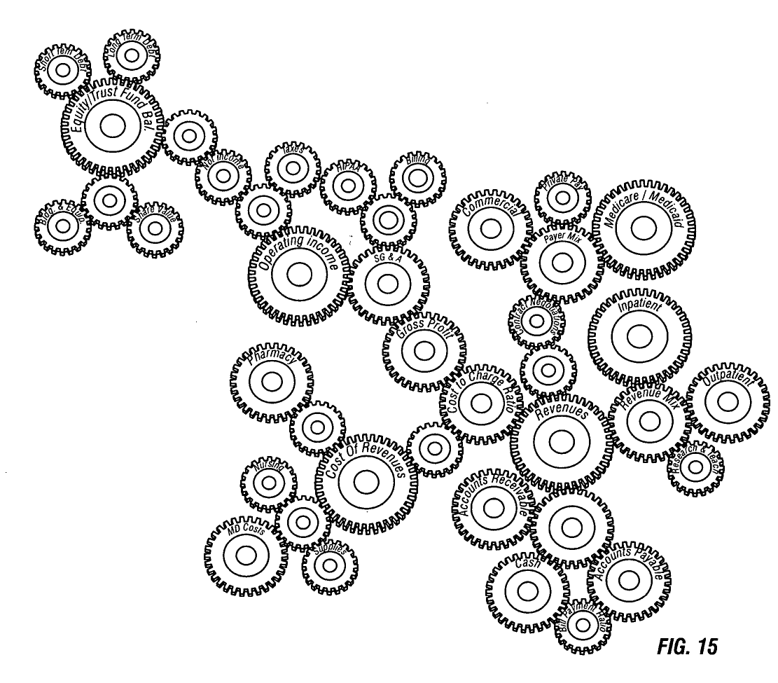

Step 7, referring to FIG. 15, adds yet more gears. Operating Income is a driver that is a measure of profitability based on operations. It answers the question, “Is the operational foundation profitable?” Taxes have a direct impact on Shareholder Equity—if taxes go up, Shareholder Equity goes down. After a system pays taxes on its Operating Income, the remainder is their Net Income (or loss)—the bottom line. Net Income is the money that is left over after all other Expenses and obligations have been paid. Short-term debt and long-term debt have an inverse impact on Shareholder Equity. As a company takes on debt, that debt will dilute the Shareholder Equity held by other owners until the debt is retired.

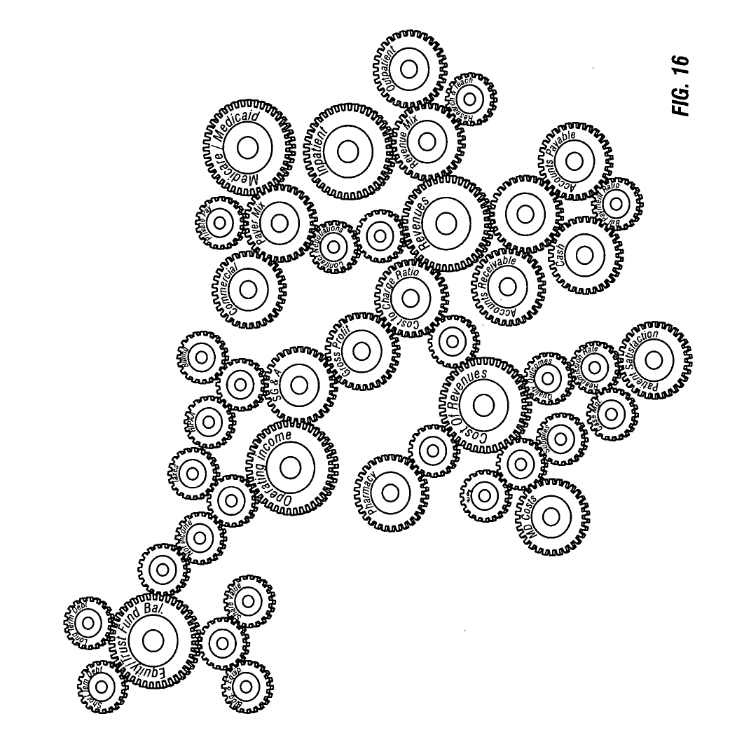

Step 8, referring to FIG. 16, adds final gears that are perhaps the most important drivers in the entire system, including Patient Satisfaction and Quality Outcomes. These drivers are not quantified on an Income Statement or a Balance Sheet, but they can have dramatic effects on the profitability of a hospital system. Moving the Patient Satisfaction gear counter-clockwise (indicating, perhaps, a decrease in patient satisfaction with the system's services or products or both) will cause negative effects on Revenues and Operating Income.

Now that the system is complete, note that there tend to be some general patterns of money and information flow. The right side of the system represents sources of revenue. The general flow of money is inward and to the left side of the system. The left side of the system can be divided into two main areas: the bottom left side represents costs of doing business, and the upper left side represents the money left over after the costs of operations are covered.

In a hospital system setting, billing and administrative staff will most often be concerned with SG&A costs, Payor Mix, Revenue Mix, and Cash Management groups. The clinical staff will focus most on the staff and materials needed to deliver healthcare as well as the quality of service given. All stakeholders have an interest in the upper left gears, particularly Net Income. If Net Income indicates a profit, that is good news for all; if it is a loss, bad news for all.

The preceding examples can be repeated with similar success by substituting other types of businesses or organizations for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of displaying information about an organization, the method comprising the steps of:
representing a plurality of factors of the organization as a corresponding plurality of displayed interlocking gears; and
causing the displayed gears to rotate in accordance with simulated increasing or decreasing of the corresponding factors.

2. The method of claim 1 wherein the causing step results in directly interlocking gears rotating in opposite directions.

3. The method of claim 2 additionally comprising the step of displaying facilitating gears interlocking two gears corresponding to two factors of the organization which increase and decrease together.

4. The method of claim 1 wherein the representing step comprises representing a plurality of factors selected from the group consisting of organization membership, costs, revenues, cost of revenues, gross profit, operating income, net income, taxes, accounts payable, accounts receivable, and equity.

5. The method of claim 1 additionally comprising the step of permitting a user to click on a gear to receive a graphical display of change of the corresponding factor over time.

6. The method of claim 1 additionally comprising the step of graphically alerting a user via a corresponding gear if a factor exceeds or falls below a predetermined set point.

7. The method of claim 1 wherein the causing step is executed via an HTML browser.

8. The method of claim 1 additionally comprising the step of permitting a user to change a speed at which the causing step occurs.

9. The method of claim 1 additionally comprising the step of permitting a user to alter speeds at which one or more factors increase or decrease.

10. The method of claim 1 additionally comprising the step of permitting a user to load a plurality of organization's data as the factors corresponding to the gears of the display.

11. Computer software for displaying information about an organization, said software comprising code embodied in a storage medium, said code comprising:
code representing a plurality of factors of the organization as a corresponding plurality of displayed-interlocking gears; and
code causing the displayed gears to rotate in accordance with simulated increasing or decreasing of the corresponding factors.

12. The software of claim 11 wherein said causing code generates directly interlocking gears rotating in opposite directions.

13. The software of claim 12 additionally comprising code generating facilitating gears interlocking two gears corresponding to two factors of the organization which increase and decrease together.

14. The software of claim 11 wherein said representing code comprises code representing a plurality of factors selected from the group consisting of organization membership, costs, revenues, cost of revenues, gross profit, operating income, net income, taxes, accounts payable, accounts receivable, and equity.

15. The software of claim 11 additionally comprising code permitting a user to click on a gear to receive a graphical display of change of the corresponding factor over time.

16. The software of claim 11 additionally comprising code graphically alerting a user via a corresponding gear if a factor exceeds or falls below a predetermined set point.

17. The software of claim 11 wherein the causing code is executed via an HTML browser.

18. The software of claim 11 additionally comprising code permitting a user to change a speed at which the causing step occurs.

19. The software of claim 11 additionally comprising code permitting a user to alter speeds at which one or more factors increase or decrease.

20. The software of claim 11 additionally comprising code permitting a user to load a plurality of organization's data as the factors corresponding to the gears of the display.
